(19) United States
(12) Patent Application Publication
(10) Pub. No.: US 2010/0074486 A1
(43) Pub. Date: Mar. 25, 2010

(54) RECONSTRUCTION AND VISUALIZATION OF NEURONAL CELL STRUCTURES WITH BRIGHT-FIELD MOSAIC MICROSCOPY

(75) Inventors: Philip J. Broser, Birchington on Sea (GB); Marcel Oberländer, Munchen (DE)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: Max-Planck-Gesellschaft zur Forderung der Wissenschaften e.V., a corporation of Germany, Munchen (DE)

(21) Appl. No.: 12/513,424

(22) PCT Filed: Nov. 22, 2006
(86) PCT No.: PCT/EP06/11194

§ 371 Date: May 4, 2009

(51) Int. Cl. G06T 7/00; G06T 5/50; G06K 9/40

(52) U.S. Cl. 382/128; 382/260; 348/79; 345/419

(57) ABSTRACT

A method of reconstructing an image of a neuronal cell structure from a recorded image includes an image stack of image layers recorded with a bright field microscope, including forming a corrected image by deconvoluting the recorded image, wherein deconvoluting includes applying a linear deconvolution to the image stack on the basis of a point spread function of the bright field microscope, which point spread function is calculated on the basis of measured features of the bright field microscope, and extracting a cell structure image from the corrected image.

### RELATED APPLICATION

This is a §371 of International Application No. PCT/EP2006/011194; with an international filing date of Nov. 22, 2006 (WO 2008/061548 A1, published May 29, 2008).

### TECHNICAL FIELD

This disclosure relates to a method of reconstructing an image of a neuronal cell structure, in particular of at least one of axons, a cell body and dendrites, to an imaging method for imaging the neuronal cell structure, and to devices adapted for implementing these methods.

### BACKGROUND

To understand morphology and functionality of brains, various model systems are currently in use. One widely used one is the barrel cortex of the rat brain is a widely used model system for physiological, functional and morphological studies in the rat brain. This is due to the clear morphological distinction of each barrel and its functional connection to a single whisker. Based on the patch clamp technique a variety of electro-physiological experiments yield excessive data about information processing within a single neuron cell. However, these data can only be validated if the morphology of this cell is known. Further, information of where the dendritic (neuronal input device) and the axonal (neuronal output device) tree project to is essential for any deeper understanding of neuronal information processing.

The current and widely used approach to obtain the three dimensional structure of single nerve cells is that a human operator interacts with a microscope that is enhanced with computer imaging hardware and software. The user performs pattern recognition and traces each neuronal structure of interest by focusing through the specimen and manually moving the microscope stage. The computer system then collects this data and allows for various morphological and topological analysis. The major disadvantage of this method is the subjective pattern recognition of the human operator, which in consequence makes it almost impossible to reproduce the reconstruction (see D. Jaeger in “Computational Neuroscience: Realistic Modelling for Experimentalists” CRC Press Boca Raton, Fla., 2001, Chapter: Accurate reconstruction of neuronal morphology, pages 159-178). The method is further very time consuming.

Previous approaches for automatic reconstruction of single neurons are based on an automatic segmentation, skeletonization and graph extraction of three dimensional images of brain slices obtained from a confocal or a transmitted light bright field (TLB) microscope. W. He et al. have proposed an automatic method to reconstruct cell structures comprising the steps of deconvolution of a recorded image and extraction of a cell structure (see W. He et al. “Microscopy and Microanalysis,” vol. 9, 2003, p. 296 to 310). The method of W. He et al. has the following disadvantages. Firstly, the deconvolution is based on a blind iterative calculation of a point spread function, which introduces artefacts into the image. Furthermore, the iterative concept yields an extremely time consuming image processing. Furthermore, the conventional method is restricted to the reconstruction of dendritic cell structures, which occupy a relatively small volume around a cell body. Axonal cell structures occupy a volume being larger by a factor of about 100 compared with the dendritic cell structures. Accordingly the size of a single image would increase to about 20 Gigabyte (GB), which cannot be processed with the conventional iterative concept on a practically acceptable time scale. Finally, the conventional method has disadvantages in terms of recognizing low contrast cell structures.

A further major limitation of the conventional automatic reconstruction methods results from the relative large dimension of the entire neuronal cell, which may extend over more than 1 mm. However, the conventionally used TLB microscope has a limited field of view of about 100 microns that makes it impossible to reconstruct the entire cell. As an alternative, confocal microscopy is not capable to image the entire cell in terms of measurement time and stability of the sample, i.e., bleaching.

The recently developed mosaic scanning technology (see e.g., S. K. Chow et al. in “Journal of Microscopy,” vol. 222, 2006, p. 76) is capable to compensate for the above limitation by scanning a user defined array of adjacent fields of view that are automatically aligned during the scanning process. This is achieved by very accurate x/y sensors. The conventional mosaic scanning technology is restricted to two-dimensional imaging, for instance imaging of blood vessels patterns. The ability of scanning areas on a mm range of the brain slices would be the key prerequisite for the automatic reconstruction of extensively spreading axonal arbors. However, an increase of the area of interest within the brain slice would result in a dramatic increase of data size of the scanned image stack. For example, a typical three dimensional image of the size of 1 mm×1 mm×100 μm occupies a data volume of approximately 15 GB. Image processing of large sized data sets would require extremely large processing times of days or even weeks, which is unacceptable for routine investigations of neuronal cells.

It could therefore be helpful to provide an improved method of reconstructing an image of a neuronal cell structure from a recorded image, which method is capable to avoid the disadvantages of the conventional image reconstruction procedures. Furthermore, it could be helpful to provide an improved method of imaging a neuronal cell structure and devices for implementing the reconstructing and imaging methods.

### SUMMARY

According to a general first aspect, we provide a method of reconstructing an image of a neuronal cell structure, in particular at least one of axons, a cell body and dendrites, e.g., the axonal arbor, comprises a first phase of correcting a recorded image comprising an image stack of image layers recorded with a bright field microscope, wherein the correction is obtained by a linear deconvolution being applied to the image stack on the basis of an optical transfer function of the bright field microscope, which optical transfer function is calculated on the basis of measured features of the microscope set-up, and a second phase of extracting a cell structure image from the corrected image. The recorded image can be read-out from a data storage containing data measured with an imaging microscope, or it can be provided directly by an imaging microscope.

The first phase in the reconstructing method is the deconvolution (image restoration) that can be used in particular as a result of simplifications of the microscope that are verified by our aberration measurements using a Shack-Hartmann wave front sensor. The optical transfer function (point spread function, PSF) is calculated on the basis of the microscope set-up measurable features including parameters of illumination and aperture, in particular including refractive indices, numerical aperture, sampling step widths and imaging wavelengths, especially comprising the refractive index of an immersion medium, the refractive index of the sample, the numerical aperture of the objective, the x/y sampling step width, the z sampling step width, the illumination (excitation) wavelength, and the imaging (emission) wavelength. Accordingly, the PSF is called measured point spread function. As the used microscope is considered as well-corrected and the illumination within the object plane (image layer) due to the extended quasi-monochromatic incoherent source is incoherent, the image layer can be considered as self illuminating (by inverting the intensities), so that the optical system can be simplified to the circular entrance pupil of the objective. The three-dimensional light distribution behind a circular aperture, due to a point source, is represented by the three-dimensional PSF for the incoherent optical systems.

We found that a bright field microscope, in particular a transmitted light microscope is sufficient in resolution and image quality for an automatic and effective detection of the neuronal cell structure through an automatic three dimensional image analysis method. The method allows to reconstruct entire neuronal cells of mammals, e.g., from the barrel cortex of rat-brains. The automatic image analysis is capable to process large data images to extract any neuronal structure within the image and to collect morphological information.

The image to be reconstructed is an image recorded with a bright field microscope having a well-corrected optical system with an essentially monochromatic illumination providing an image with negligible coherence. Preferably, the recorded image is an image with inverted intensities. The term “well-corrected optical system” means that the optical system is essentially free of spherical aberrations. The term “negligible coherence” refers to the fact that the recorded image is free of interference patterns or fringes.

According to a preferred aspect, the deconvolution step of the reconstruction method comprises an application of a linear image restoration filter, such as the application of the Tikhonov-Miller deconvolution filter. Preferably, the Tikhonov-Miller-deconvolution is based on a measured point spread function of the bright field microscope. The Tikhonov-Miller deconvolution filter (see G. van Kempen et al. in “SPIE Photonics West” 1999, page 179-189, San Jose, Calif., USA) is a linear image restoration filter.

Advantageously, the application of the linear filter is based on the assumption that the imaging system used for providing the recorded image can be treated as if it were a fluorescent microscope that suffers from no aberrations. This assumption results from a consideration of the propagation of mutual intensity (coherence) and is verified by aberration measurements on the microscope using a Shack-Hartmann wave front sensor (Beverage et al. in “Journal of Microscopy,” vol. 205, 2002, p. 61-75). In particular, these simplifications allow an improved description of the image formation process in terms of the point spread function (PSF) (see P. J. Shaw in “Handbook of Biological Confocal Microscopy,” chapter 23, page 373-387, Plenum Press, New York, 1995).

According to a further preferred aspect, the corrected image is subjected to a further image processing in the image extraction step. Firstly, a local connectivity threshold filter is applied for providing a filtered image. Subsequently, each of the image layers of the filtered image can be subjected to an erosion and dilation transformation for providing an object image. Finally, the object image is subjected to a region growing algorithm adapted for assigning an individual label to predetermined foreground objects representing the cell structure image. Local threshold, neighborhood connectivity and object labelling filters transform the deconvolved image stack into a segmented three dimensional image (the object image) of individual, labelled foreground objects.

The object image obtained by the above image extraction step can be provided as the cell structure image of interest. In particular, the object image can be recorded, displayed and/or stored for further application.

Alternatively, the object image is subjected to a further step of converting the labelled objects to a list structure especially created for this task. The objects are extracted from the image stack and stored in the list structure. As the list preserves the original image topology and a plurality of information vectors representing prior voxels and its neighborhood, the data size representing the cell structure image of interest can be essentially reduced. In particular, the image to list conversion yields a reduction of data size of the order of more than 1000, depending on the amount of structure in the image stack.

According to a further preferred aspect, the list of objects is subjected to a skeletonization algorithm. Preferably, template based thinning algorithms are used to skeletonize the objects. Subsequently, the graph and the radii can be computed based on the skeletonized objects. Advantageously, the skeletonization algorithm yields an increased efficiency in terms of reconstruction time and objectivity, which further increases the reproducibility of the reconstruction to a maximum.

In particular, template based thinning algorithms (see e.g., P. P. Joncker in “Pattern Recognition Letters,” vol. 23, 2002, p. 677-686) and morphological filters extract a three dimensional graph representation of the nerve cell and information such as radii of dendrites and axons or axonal length.

According to further aspects, the list structure or a representation derived from the list structure by the above further processing, preferably the three dimensional graph representation can be provided as the cell structure image of interest. In particular, the three dimensional graph representation can be recorded, displayed and/or stored for further application. Advantageously, the visualization of neuronal morphology enables the three dimensional reconstruction of neurons including their entire dendritic and axonal arbor and then a quantitative measurement allows collection of data such as axonal length, density or radii.

According to a general second aspect, an imaging method is provided for imaging a neuronal cell structure, comprising a first step of recording an image stack of image layers of a neuronal cell structure with a bright field microscope and a second step of subjecting the recorded image to the reconstruction method according to the above first aspect.

Preferably, the image layers are recorded by so-called mosaic scanning that advantageously allows for scanning a sufficient area of the cortex. Mosaic scanning comprises recording a plurality of mosaic field images covering the region of interest, e.g., a portion of a brain slice, and representing compositions of adjacent fields of views of the bright field microscope into mosaic patterns each of which forming one of the image layers. Advantageously, we provide for the first time a combination of high resolution transmitted light bright-field-mosaic microscopy with automatic reconstruction and e.g., visualization of neurons. We yield reproducible neuron morphologies within a few hours. Our results show that the computerized analysis of image stacks, acquired through optical sectioning with a bright field mosaic microscope, yield an accurate and reproducible reconstruction of dendritic and axonal structure that is faster and more reliable than the semi automatic approaches currently in use. In addition morphological information can be obtained during the reconstruction process.

According to a particularly preferred aspect, the mosaic scanning is combined with the further deconvolution and image to list conversion steps of the above reconstructions method. This combination yields in particular the following advantages. First the mosaic technology compensates for the limited field of view of a microscope and enable the user to define an appropriate and sufficient scan area. This is the only interaction of a human operator and the reconstruction pipeline. Therefore, the conventionally necessary “man-power” of a few hours for reconstructing the morphology of a brain slice is replaced by a significantly less amount of “man-power” (e.g., around 30 min) plus a few hours of automatic “computer-power.” This “computer-power” includes the second and the third fundamental steps. The image restoration (deconvolution) based on the verified assumptions that the transmitted light bright field microscope can be treated as if it would consist of a self luminous specimen and the circular entrance pupil only. This step yields an imaging quality sufficient for the last step to extract the neuron structures. This is based on a data structure that reduces the data size up to 10⁴ times, increases the valuable information and allows parallel processing. This concept is the basis for a rather fast reconstruction, which will become even faster with increasing computer power. Accordingly, we provide for the replacement of the conventional semi-automatic reconstruction tools for single brain slices. Further, this way of reconstruction saves time and yields reproducible morphologies.

If, according to a further preferred aspect, a plurality of mosaic image stacks by optical sectioning for each field of view are recorded and subsequently aligned to the image stack of image layers, advantages in terms of mosaic scanning with a minimum overlap of neighboring stacks and reduced artefacts can be obtained.

Preferably, at least one of the following measures is provided with the bright field microscope for improving the result of deconvolution of the recorded images. Firstly, the sample, e.g., brain slice, including the neuronal cell structure is measured in the bright field microscope with an oil immersion objective. Furthermore, the sample is embedded in a polymer cover material using a polymer forming a transparent clear cover layer, preferably with a polyvinyl alcohol based cover, like, e.g., a cover layer made of Mowiol (commercial trade name, see also “Archives of Acarology List, Microscope Slide Mounting Media”, 15 Jun. 1994, R. B., Halliday). Finally, the sample is preferably illuminated with quasi monochromatic illumination light, in particular with illumination light subjected to an optical band filter.

According to a further particularly preferred aspect, the recorded image is subjected to a step of inverting measured intensities. Inverting measured intensities in particular comprises replacing each measured value by an inverted (negative) value. Accordingly, the neuronal cell structure to be obtained can be considered as self illuminating resulting in facilitated calculations in further image processing.

According to a general third aspect, a reconstruction device is provided for implementing the reconstructing method according to the above first aspect. The reconstruction device comprises a deconvolution circuit adapted for implementing the deconvolution of the to recorded image for providing a corrected image and an extraction circuit adapted for implementing the extraction of a cell structure image from the corrected image. Preferably, the deconvolution circuit is adapted for applying the deconvolution to the image stack of the recorded image on the basis of measured properties of the point spread, function of the bright field microscope.

According to preferred aspects, the reconstruction device comprises a threshold filter circuit implementing a local connectivity threshold filter on each of the deconvolved image layers and a transformation filter circuit applying an erosion and dilation transformation on each of the filtered image layers for providing the object image to be obtained. Furthermore, a region growing circuit can be provided, which is adapted for assigning an individual label to predetermined foreground objects included in the object image. The region growing circuit is preferably followed by a conversion circuit adapted for converting the labelled objects to a list of the objects, wherein the list preserves an original image topology and each object in the list comprises a plurality of information vectors representing prior voxels and its neighborhood. An extraction circuit, following the conversion circuit can be arranged for extracting a three-dimensional graph representation from the object image. The extraction circuit comprises a skeletonization circuit and yields a three-dimensional graph representation of the object image.

If, according to further preferred aspects, the reconstruction device includes at least one of a recording device, a display device and a data storage, advantages in terms of the extended functionality of the reconstruction device are obtained.

According to a general fourth aspect, an imaging device is provided comprising the reconstruction device according to the above third aspect and a bright field microscope, in particular a transmission bright field microscope. Preferably, the bright field microscope is combined with a mosaic scanning device.

Further independent subjects are a computer program residing on a computer-readable medium, with a program code for carrying out the reconstructing method, and an apparatus comprising a computer-readable storage medium containing program instructions for carrying out the reconstructing method.

### BRIEF DESCRIPTION OF THE DRAWINGS

Further details and advantages are described in the following with reference to the attached drawings, which show in:

FIG. 1: a schematic representation of an imaging device;

FIG. 2: a flow chart illustrating embodiments of an imaging/reconstructing method;

FIG. 3: a photograph illustrating a recorded image;

FIG. 4: photographs illustrating a deconvolution result;

FIG. 5: a flow chart illustrating further details of the image extraction step;

FIG. 6: images obtained with the image extraction step;

FIG. 7: a schematic representation of an object list representation; and

FIG. 8: images obtained with the reconstructing method.

### DETAILED DESCRIPTION

The reconstructing and imaging methods are described in the following with reference to key functionalities of the deconvolution and the image processing phases including neuron specific filtering and segmentation, graph based morphological filtering, quantitative measurements and visualization of neuronal properties, large data handling and parallel processing. Details of controlling the microscope, implementing the algorithms or representing the image of the neuronal cell structure are not described as far as they are known from prior art.

### Preferred Aspects of an Imaging Device

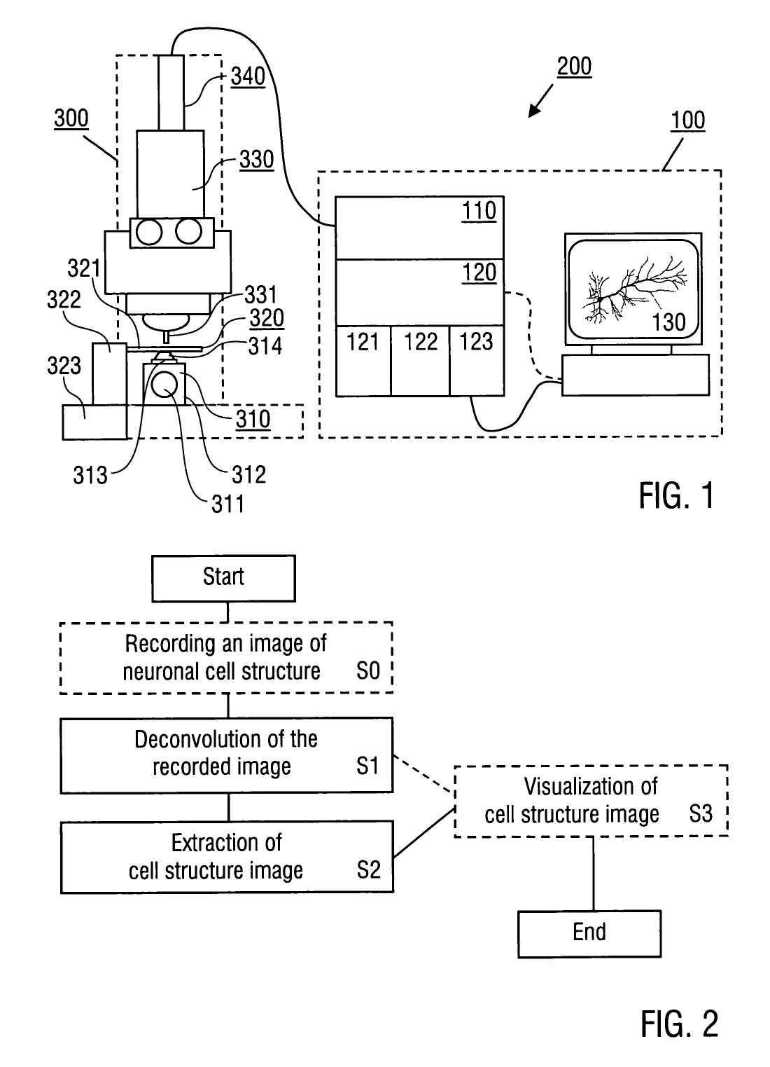

FIG. 1 illustrates an embodiment of an imaging device 200 including a reconstruction device 100 and a bright field microscope 300. The bright field microscope 300 is a standard transmitted light bright field microscope (e.g., Olympus BX-51) comprising an illumination source 310, a sample stage 320, an imaging optic 330 and a camera device 340.

The illumination source 310 comprises a standard microscope lamp 311 accommodated in a light house 312. A band pass illumination filter 313 is placed right behind the exit diaphragm of the light house 312. The filter 313 is adapted for providing quasi-monochromatic illumination of the sample on the sample stage 320. To this end, the filter 313 preferably transmits light with a wavelength of, e.g., 546+5 nm. Furthermore, an oil immersion condenser 314 with a high numerical aperture (e.g., N.A.=1.4) is provided on the illumination side of the sample stage 320.

The sample stage 320 comprises a platform 321 providing a transparent substrate which accommodates the sample (not shown), and a driving device 322 being adapted for adjusting the position of the sample relative to the optical path from the lamp 311 to the imaging optic 330. To this end, the driving device 322 includes a motorized xyz stage being capable to move and adjust the platform 321 with regard to all three directions x, y and z in space. The driving device 322 is navigated in the space directions by a commercial available control device 323, e.g., OASIS-4i-Controller Hardware and Software (Objective imaging Ltd.), which allows the acquisition of large mosaic images at different focal planes.

The driving device 322 and the control device 323 provide a mosaic scanner, which is adapted for the acquisition of the mosaic images. The acquisition of the mosaic images is preferably based on an optical sectioning process, which has been described by D. A. Agard in “Annu. Rev. Biophys. Bioeng.”, Annual Reviews Inc., 1984. The optical sectioning process of mosaic planes is carried out by a commercial software like, e.g., the interactive Surveyor software (Objective Imaging Ltd.).

The imaging optic 330 includes an oil immersion objective 331 with high numerical aperture (N.A.=1.3), like, e.g., Olympus 40× U PLAN FL N. Advantageously, the high numerical aperture oil immersion condenser and objective minimize aberrations within the optical path way as outlined below.

The camera device 340 comprises a CCD camera, like, e.g., type “Q-icam.” As an example, the CCD chip of the Q-icam camera in combination with the 40× objective yields an x/y sampling of 116 nm per pixel of the CCD chip. The output of the camera device 340 is connected with the reconstructing device 100. Preferably, the camera device 340 is cooled during operation. Advantageously, cooling of the camera device 340 allows the application of short recording times, so that deteriorating influences on the sample can be avoided.

The advantages of the reconstruction method in particular have been obtained on the basis of the following features of the bright field microscope 300. Firstly, the degree of coherence within an object-plane, which is trans-illuminated by the extended quasi-monochromatic incoherent illumination source 310, can be neglected. This feature is provided, if the ratio between the radius of the illumination source 310 and the radius of the entrance pupil of the objective 311 is larger than 2, preferably at least 5, which is the value in the used imaging system. This ratio condition is in particular fulfilled with the present bright field microscope 300, which is adapted for Koehler illumination. As a result, any coherence effects within the objective plane can be neglected, and conventional concepts of image formation with selfluminous objects can be used for analyzing the image recorded with the camera device 340. Inverting measured intensities can be implemented with the camera device 340 or the subsequent reconstruction device 100.

The second feature of the bright field microscope 300 used is the fact that the optical system, in particular comprising the components arranged in the optical path from the illumination source 310 through the sample stage 320 and the imaging optic 330 to the camera device 340 is a so-called well-corrected optical system. We found on the basis of a direct measurement of spherical aberrations using a Shack-Hartmann wave-front sensor that primary spherical aberrations do not occur if the refractive index mismatch between the sample, the intermediate medium and the glass of the objective 331 is minimized. In particular, the optical system is well-corrected if the maximum deviation of the wave-front from the Gaussian reference sphere is less than 0.94 times the illumination wavelength (see, e.g., Born and Wolf “Principles of Optics,” Cambridge University Press, Ind edition, 2003, p. 532).

The well-corrected condition of the optical system has been provided in particular by using an oil immersion objective with an immersion oil having an refractive index nₒᵢₗ=1.516 and an embedding of the sample into a polymer, like, e.g., Mowiol or in Mowiol embedded tissue having a refractive index n_{mowiol}=1.49 or nₜᵢₛₛᵤₑ=1.44, resp.

On the basis of the features of incoherence and well-correction of the optical system, the image formation process within the transmitted bright field microscope 300 can be simplified to the case of image formation of an incoherent object image by a circular aperture. This can be described by a convolution of the object function with the point spread function (PSF):

I₁₍ₓ_{₁}_{,y}_{₁}_{,z}_{₁})=∫I₀₍ₓ_{₁}₋ₓ_{₀}_{,y}_{₁}_{-y}_{₀}_{,z}_{₁}_{-z}_{₀})(PSF)d³x₀ (1)

or, having a pixel image, with matrix notation, wherein the three dimensional integral is replaced by discrete sums:

I=(PSF)I₀+n (2)

where I₀, I and n denote vectors respectively of the object, its image and additive Gaussian noise, and (PSF) is the blurring matrix representing the point spread function of the microscope (see van Kempen et al. in “SPIE Photonics West” 1999, page 179-189, San Jose, Calif., USA). The point spread function can be expressed analytically in terms of Lommel functions (see, e.g., Born and Wolf “Principles of Optics,” Cambridge University Press, 7nd edition, 2003, p. 487) or numerically modelled (see J. Philip in “Journal of Modern Optics,” vol. 46, 1999, p. 1031-1041).

The reconstruction device 100 comprises a deconvolution circuit 110, an extraction circuit 120 including a threshold filter circuit 121, a transformation filter circuit 122 and a region growing circuit 123, and a display device 130. In practice, the reconstruction device 100 can be provided with a special hardware arrangement including adapted image processing circuits or alternatively with a standard computing device, like, e.g., a personal computer. Further to the illustrated components, the reconstruction circuit 100 may include at least one of a data storage, a printer and further standard data processing components.

FIG. 1 illustrates the reconstruction device 100 as being connected with the microscope 300. In particular, the camera device 340 is directly connected with the deconvolution circuit 110, so that images recorded with the microscope 300 can be immediately reconstructed for providing an image of the cell structure to be obtained. It is emphasized that the reconstruction circuit 100 represents an independent subject. Accordingly, the deconvolution circuit 110 can be connected with any data storage for accommodating a recorded image of a sample rather than with the microscope.

### Preferred Aspects of Reconstruction/Imaging Methods

FIG. 2 illustrates the general steps of an imaging method. With a first step, an image of the neuronal cell structure is recorded with the transmission bright field microscope 300 (step S0). Subsequently, the recorded image is subjected to a deconvolution for obtaining an object image (step S1). According to one aspect, this object image is considered as the cell structure image to be obtained. In this case, the object image can be visualized or further processed immediately after deconvolution (step S3). According to an alternative, the object image is subjected to an extraction of a cell structure image (step S2), which subsequently is visualized or further processed (step S3).

### Recording Step (S0)

Step S0 includes a first sub-step of sample preparation. The sample preparation includes embedding a brain slice (thickness, e.g., 100 μm) in Mowiol, which after fixation forms a dry, sufficiently stable layer. The brain slice layer is arranged on the platform 321 of the sample stage 320 (see FIG. 1). Subsequently, an immersion oil is provided on the brain slice layer, and the condenser and the objective 331 is adjusted. Microscope adjustment and camera control are implemented as it is known from conventional microscopy. The following sub-step of step S0 includes the provision of the recorded image as a mosaic image as follows.

The recorded image comprises an image stack of image layers. Each image layer comprises a plurality of partial images each of which corresponding to the field of view of the microscope 300. The partial images are collected by mosaic scanning, which is controlled by an appropriate mosaic scanning software (commercially available) controlling the driving device 322 and combining the mosaic images. Advantageously, setting of a scan pattern and a focal plane separation are the only work that have to be performed by the user for reconstructing the morphology from a single brain slice. Each of the image layers (mosaic field images) corresponds to a predetermined focal plane within the sample.

Each of the partial images (field of view) has a typical dimension of, e.g., 100 μm. Accordingly, with a dimension of the neuronal cell of about 2 mm, about 400 partial images are collected in each image layer. With a sample thickness of about 100 μm and a separation of the focal planes of 0.5 μm, about 200 image planes are collected. The corresponding recorded image comprises a size of, e.g., 10 to 30 GB.

Preferably, the mosaic scanning is implemented with a predetermined scan pattern of partial image collection. Firstly, all partial images according to the various focal planes (separation in z-direction) are collected with a fixed field of view (fixed x- and y-adjustment of the objective). Subsequently, the next field of view is adjusted followed by the collection of the corresponding partial images in all focal planes. This scanning mode is repeated until all partial images of all image layers are recorded. Finally, all partial image of all focal planes are combined to the recorded image (image stack of image layers). The deconvolution starts automatically after the stack is saved.

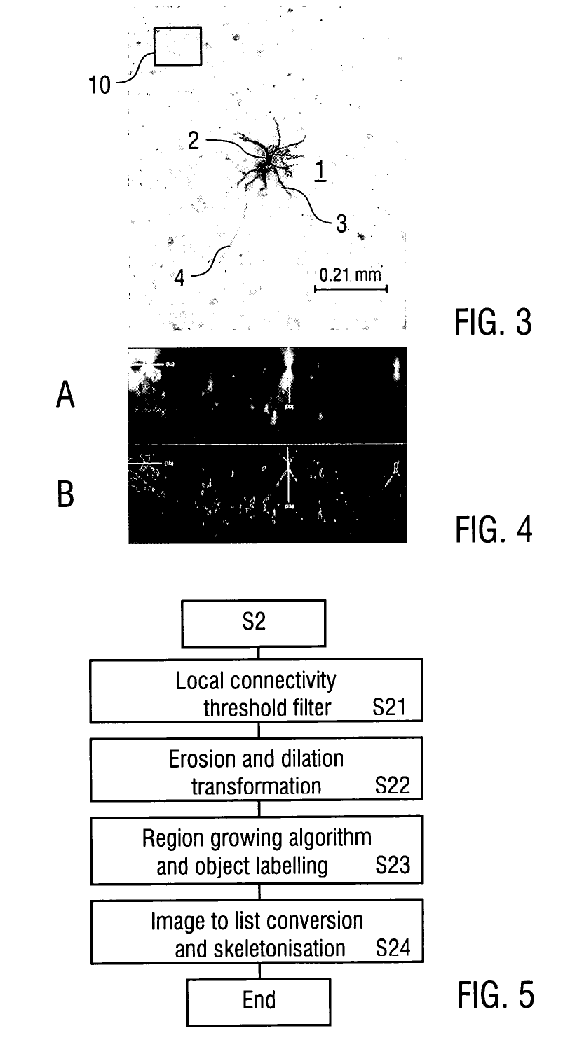

FIG. 3 illustrates a portion of a 2-dimensional mosaic image of the Layer 5 pyramidal neuron of the barrel cortex in the rat brain. The whole image layer covers an area of 3.63 mm² and consists of 224 partial images (fields of view). One single field of view is schematically illustrated with frame 10. The image layer includes a portion of the neuronal cell 1 with a cell body 2, dendrites 2 and axons 4. In practical use, the neuronal cell 1 forms a bright pattern with a dark background. In FIG. 3, a negative print-out has been illustrated for clarity reasons.

### Deconvolution Step (S1)

As seen in equations (1) and (2), the image formation process is described as a convolution of the original intensity distribution with a point spread function. With step S1, the convolution is reversed using a linear deconvolution of the image stack of the recorded image.

Preferably, the linear deconvolution comprises a deconvolution using the so called Tikhonov-Miller deconvolution Algorithm™, which is a deconvolution filter operating on the measured image. It can be written as

Ĩ₀=WI (3)

where W is the linear restoration filter and Ĩ₀ its result. The Tikhonov-Miller filter is derived from a least square approach, which is based on minimizing the squared difference between the acquired image and a blurred estimate of the original object:

∥(PSF)Ĩ₀−I∥² (4).

The direct minimization produces undesired results, since equation (4) does not take into account the (high) frequency components of Ĩ₀ that are set to zero by the convolution with PSF. To address this issue Tikhonov defined a regularized solution Ĩ₀ of Equation (4), which minimizes the well-known Tikhonov functional (see the above publication of van Kempen et al.).

Since the illumination is incoherent and the imaging system is well-corrected (see above), the sample can be reduced to a self luminous specimen and the circular entrance pupil of the objective. In this case, the point spread function can be calculated on the basis of measured parameters. The calculation is implemented on the basis of algorithms described in the above textbook of Born and Wolf (“Principles of Optics”, Cambridge University Press, 7nd edition, 2003). The generation of the point spread function, including numerical modifications using parameters specific to the used microscope, preferably is carried out by a commercial software (e.g., the Huygens software, Scientific Volume Imaging). As an example, the point spread function is calculated on the basis of the refractive index of the immersion medium 1.516, the refractive index of the sample 1.44, the numerical aperture 1.0, the x- and y-sampling step width 116 nm, the z-sampling width 500 nm, the excitation wavelength 546 nm, and the emission wavelength 546 nm.

The linear nature of the TM filter makes it incapable of restoring frequencies for which the PSF has zero response. Furthermore, linear methods cannot restrict the domain in which the solution should be found. Iterative, non-linear algorithms could tackle these problems in exchange for a considerable increase in computational complexity. Since the data is of the size of several Gigabytes, computational complexity plays a key role. The TM filter proved to be the most efficient filter yielding stable results in sufficient quality for the neuron reconstruction, within reasonable time.

FIGS. 4A and 4B show exemplary results of deconvolution with an image of the x-z plane before (3A) and after (3B) the deconvolution. The intensity plots show a significant gain in resolution, especially along the optical axis and further a significant increase of the signal to noise ratio.

### Extraction Step (S2)

FIG. 5 illustrates further details of image processing after deconvolution as outlined in the following. With a first sub-step S21, a local connectivity threshold filter is applied to the object image obtained by deconvolution. Subsequently, an erosion and dilation transformation is implemented (sub-step S22) and the image is subjected to a region growing and object labelling algorithm (sub-step S23). Finally, an image to list conversion and a skeletonization are applied (sub-step S24).

### Local Connectivity Threshold Filter (S21)

The image quality after the deconvolution is sufficient for an automatic extraction of the neuron morphology. First a global threshold assigns pixels below a certain threshold (e.g., mean intensity value plus one standard deviation of the grey-value histogram of the image stack, usually between 5 and 25) to zero and pixels above another threshold (e.g., 30) to 255. Intermediate pixels are left unchanged. This group consists usually of isolated artefacts or dim bridges between the so called axonal boutons that usually belong to the foreground.

Local thresholding is based on an operation that involves tests against a function T

T=T_{[x,y,z;p(x,y,z);f(x,y,z)}]

where f(x,y,z) is the grey level of a point (x,y,z) and p(x,y,z) denotes some local property of this point (see R. C. Gonzalez et al. “Digital Image Processing” Prentice-Hall, Inc., Upper Saddle River, N.J., 2nd edition, 2002). The local threshold function p(x,y,z) checks the amount of foreground pixels in a two dimensional neighborhood of the intermediate pixel (x,y,z). If the grey-value of this center pixel is below the mean grey-value plus 5 of a 5×5 neighborhood, the pixel is assigned to an intermediate grey-value. If further more than 5 pixels of a 8×8 neighborhood of these intermediate pixels belong to foreground, the pixel is assigned to foreground as well. In the opposite case isolated intermediate pixels are referred as artefacts and assigned to background.

The threshold image is then defined as:

$${g}_{( x , y , z )} = \{ \begin{matrix}255 , if {f}_{( x , y , z )} > T \\ 0 , if {f}_{( x , y , z )} \leq T .\end{matrix}$$

As T depends on f(x,y,z) and p(x,y,z), the threshold is called local.

### Erosion and Dilation Transformation (S22)

Next an erosion operation removes small, isolated artefacts. Then a dilation operation bridges gaps between boutons of the axonal tree that have not been closed during the local threshold operation.

Erosion and dilation are algorithms that work on sets of pixels (see above textbook of R. C. Gonzalez et al.). The simplest application of dilation and erosion are bridging gaps and eliminating irrelevant detail (in terms of size) respectively. The dilation of an image followed by erosion is called closing. Its geometrical interpretation is that a “ball” rolls along the outside boundary of an object (set) within the image. This algorithm tends to smooth sections of contours and fuses narrow breaks and long thin gulfs, eliminates small holes, and fills small gaps in the contour.

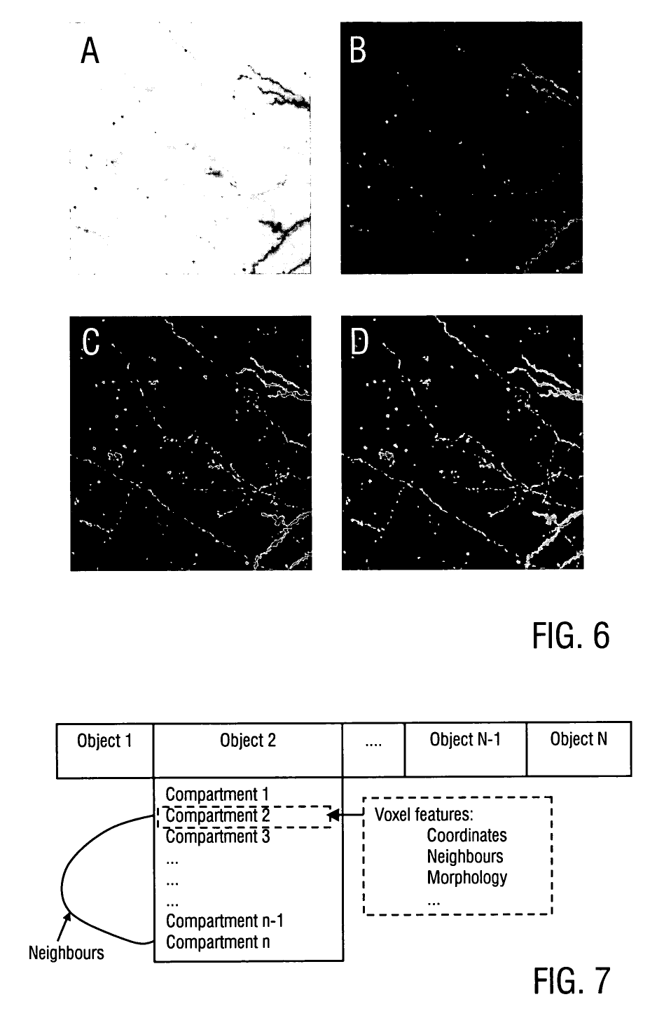

All these filters, completed by the closing, are described in more detail below and use parts of the ITK library (ITK Software guide, www.itk.org). The result is that this way of segmentation converts the doted lined axons, to almost completely connected contours as can be seen in FIG. 6.

FIG. 6 illustrates a portion of an image layer with different steps of image recording and processing. FIG. 6A shows a minimum intensity projection of the original image as recorded (e.g., portion of the image illustrated in FIG. 3). After deconvolution step S1, the image according to FIG. 6B is obtained. As in FIG. 4, the deconvolution results in an improved signal to noise ratio. After applying the local connectivity threshold filter (sub-step S21), the image of FIG. 6C is obtained, wherein the bright portions indicated foreground pixels and a connected neighborhood. Segmentation on the basis of erosion and deletion transformation results in FIG. 6D showing that gaps between parts of the neuronal structure are closed.

### Region Growing and Object Labelling Algorithm (S23)

With step S23, each individual island of foreground pixels is labelled with an integer number. The object consisting of most pixels gets number 1, the smallest gets the last number. Object 0 is referred to the background. The detection of individual foreground object is done via a region growing algorithm, which is described in the above textbook of R. C. Gonzalez et al. (p. 613-615).

### Image to List Conversion and Skeletonisation (S24)

After completing the object labelling, it can be found that more than 90%, typically almost 100% of the filtered images belong to the background, which does not include any information of interest. Therefore, we introduced a new data structure into the image processing procedure, which data structure is adapted for reducing the data size per image by a factor of at least 1000, typically even by a factor of 10000. The new data structure is characterized by a list representation of the filtered image as outlined in the following. The list representation has not only the advantage of an essentially reduced data size, but also an advantageous capability of introducing further information into the image data. Further details of the image to list conversion are described with reference to FIG. 7.

FIG. 7 illustrates schematically the architecture of the new data container. Each individual, labelled object is represented as one list item. Each list item comprises a list of compartments. Each compartment is realized as a std-vector, representing a pixel by storing its three dimensional coordinates, information about its neighboring pixels and additional morphological information. Since the background object is 10³ to 10⁴ larger than all the foreground pixels together, the storage size and the processing time decrease significantly. The image to list conversion yields an information gain and a significant data reduction.

Furthermore, the storage of each individual object as an independent list of compartments (internal graph representation) allows a straight forward parallelization of the further image processing. This is done via the OpenMP standard (OpenMP standard, Rohit Chandra et al. “Parallel Programming in OpenMP” Academic Press 2001). With the use of computers with 8 and 16 CPU's respectively (e.g., Quad-Opteron Computers), the processing time decreases dramatically and therefore enables the three dimensional reconstruction of the large data stacks within a few hours, depending on the amount of objects within the stack.

The subsequent skeletonization (thinning) reduces binary image regions (objects) to skeletons. The skeletons approximate center lines with respect to the original boundaries. The thinning operation can be performed as described by P. P. Joncker in “Pattern Recognition Letters,” vol. 23, 2002, p. 677-686.

In performing the thinning operation, the following five objectives can be considered in analogy to a 2D skeletonization described by M. Seul et al. (“Practical Algorithms for Image Analysis,” chapter 4.7, page 160-63, Cambridge University Press, United Kingdom 2000): 1. Connected image regions must thin to connected line structures; 2. The thinned lines should be minimally eight-connected; 3. Approximate end-line locations should be maintained; 4. The thinning result should approximate the medial lines; and 5. Extraneous “spurs” introduced by thinning should be minimized.

To meet these objectives it is essential to determine the approximate end-line locations. These points must stay connected to preserve the topology. First the “deepest” point within an object is determined. This point functions as a seed point and the Euclidean distances to this seed are assigned to all pixels of this object. Local distance maxima are then assigned to be end-line locations if no end-line location is within a predetermined range, in particular within a 5 μm range (evaluated in Euclidean Metric). Then the thinning process can be evoked. The used approach is to peel the region boundaries, iteratively one layer at a time, until the regions have been reduced to thin lines. In each iteration, every pixel is inspected in a raster-scan order, and single pixels that are not required for preserving connectivity or maintaining end-line locations are erased.

The preservation of connectivity for the topology of a 6, 18 or 26 neighborhood is checked with the template based algorithm proposed by P. P. Joncker in “Pattern Recognition Letters,” vol. 23, 2002, p. 677-686.

Varopis morphological filters can be implemented on the above list structure:
1. Pruning of the graph is done by breaking up loops within the thinned objects, followed by an erasing of lines shorter than a certain threshold.
2. Assigning of axonal or dendritic radii is done by averaging the distances from a midline pixel to all surface pixels within a certain range.
3. Extraction of the blood vessel pattern is done by a region growing algorithm in the brightest regions of a mean intensity projection of the original image stack before the deconvolution. If the region is approximately spherical, it is assigned to be a blood vessel. This pattern can then be used as a reference of a manual alignment of the physically cut brain slices to splice them.

### 3-D Visualization Step (S3)

The visualization of a cell structure image to be obtained is done by converting the internal graph representation (list) of the objects to a mesh format to visualize the cell structure image. This conversion is preferably implemented with the commercial Amira software (www.tgs.com). Alternatively, the internal graph representation is converted to a tree format. In this case the commercial Neurolucida software (www.mbfbioscience.com/neurolucida) is preferably used.

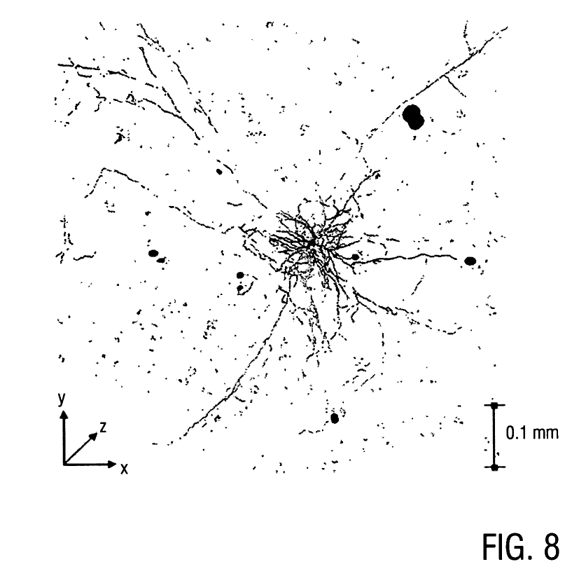

FIG. 8 illustrates an example of a visualized neuronal structure image, wherein two reconstructions of adjacent image layers are shown. The different image layers are printed in black and grey, respectively. The circles comprise patterns of blood-vessels. Both reconstructions are slightly shifted relative to each other for demonstration purposes.

The visualization of the reconstructed neuronal cell structure may comprise at least one of displaying the image layers on a display device (device 130 in FIG. 1), printing the image with a printing device and recording the image with other standard components (including storing in a data storage).

The features disclosed in the above description, the drawings and the claims can be of significance both individually as well as in combination for the realization of our methods and structures in their various forms.

1-28. (canceled)

29. A method of reconstructing an image of a neuronal cell structure from a recorded image comprising an image stack of image layers, recorded with a bright field microscope, comprising:
forming a corrected image by deconvoluting the recorded image, wherein deconvoluting comprises applying a linear deconvolution to the image stack on the basis of a point spread function of the bright field microscope, which point spread function is calculated on the basis of measured features of the bright field microscope, and
extracting a cell structure image from the corrected image.

30. The reconstruction method according to claim 29, wherein the deconvoluting comprises applying a linear image restoration filter.

31. The reconstruction method according to claim 29, wherein the extracting comprises:
subjecting the corrected image to a local connectivity threshold filter to provide a filtered image.

32. The reconstruction method according to claim 31, wherein the extracting further comprises:
subjecting each of the image layers of the filtered image to an erosion and dilation transformation to provide an object image.

33. The reconstruction method according to claim 31, further comprising:
subjecting the object image to a region growing algorithm adapted to assign an individual label to predetermined foreground objects representing the cell structure image.

34. The reconstruction method according to claim 31, wherein the cell structure image is represented by the object image.

35. The reconstruction method according to claim 33, further comprising:
converting the labeled objects to a list of objects, wherein the list preserves an original image topology and each object in the list comprises a plurality of information vectors representing prior voxels and its neighborhood.

36. The reconstruction method according to claim 35, further comprising:
applying a skeletonization algorithm to the list of objects.

37. The reconstruction method according to claim 36, further comprising:
extracting a three-dimensional graph representation from the list of objects, wherein the cell structure image is represented by the graph representation.

38. The reconstruction method according to claim 37, wherein the graph extracting comprises applying a morphological filter algorithm to the list of objects.

39. The reconstruction method according to claim 29, further comprising:
recording, storing and/or displaying the cell structure image.

40. The reconstruction method according to claim 29, wherein the neuronal cell structure comprises at least one of axons, a cell body and dendrites.

41. The reconstruction method according to claim 29, including an imaging a neuronal cell structure, comprising:
recording an image of the neuronal Cell structure with a bright field microscope, wherein the recorded image comprises an image stack of image layers, and
subjecting the recorded image to the image reconstruction method.

42. The reconstruction method according to claim 41, wherein the recording step comprises:
recording a plurality of mosaic field images covering a region of interest and representing compositions of adjacent fields of views into mosaic patterns each of which forming one of the image layers.

43. The reconstruction method according to claim 42, wherein the mosaic field image recording step comprises:
recording a plurality of mosaic image stacks by optical sectioning for each field of view within the mosaic patterns, and
aligning the mosaic image stacks to the image stack of image layers.

44. The reconstruction method according to claim 41, wherein the recording step comprises:
positioning a sample including the neuronal cell structure in a transmission bright field microscope with an oil immersion objective.

45. The reconstruction method according to claim 44, wherein recording further comprises:
illuminating the sample with monochromatic illumination light.

46. A method of imaging a neuronal cell structure, comprising:
recording an image of a neuronal cell structure with a bright field microscope, wherein the recorded image comprises an image stack of image layers, and
subjecting the recorded image to an image reconstruction method according to claim 29.

47. The imaging method according to claim 46, wherein recording comprises:
recording a plurality of mosaic field images covering a region of interest and representing compositions of adjacent fields of views into mosaic patterns each of which forming one of the image layers.

48. The imaging method according to claim 47, wherein the mosaic field image recording comprises:
recording a plurality of mosaic image stacks by optical sectioning for each field of view within the mosaic patterns, and
aligning the mosaic image stacks to the image stack of image layers.

49. The imaging method according to claim 46, wherein the recording comprises:
positioning a sample including the neuronal cell structure in a transmission bright field microscope with an oil immersion objective.

50. The imaging method according to claim 49, wherein the recording further comprises:
illuminating the sample with monochromatic illumination light.

51. A reconstruction device that reconstructs an image of a neuronal cell structure from a recorded image comprising an image stack of image layers recorded with a bright field microscope, comprising:
a deconvolution circuit that deconvolutes the recorded image and provides a corrected image, the deconvolution circuit being that which applies the deconvolution to the recorded image on the basis of measured features of a point spread function of the bright field microscope, and
an extraction circuit adapted to extract a cell structure image from the corrected image.

52. The reconstruction device according to claim 51, wherein the extraction circuit comprises:
a threshold filter circuit that subjects each of the image layers of the corrected image to a local connectivity threshold filter for providing a filtered image, and
a transformation filter circuit that subjects each of the image layers of the filtered image to an erosion and dilation transformation for providing an object image.

53. The reconstruction device according to claim 51, further comprising:
a region growing circuit that subjects the object image to a region growing algorithm that assigns an individual label to predetermined foreground objects representing the cell structure image.

54. The reconstruction device according to claim 53, wherein the region growing circuit includes a conversion circuit that converts the labeled objects to a list of the objects, wherein the list preserves an original image topology and each object in the list comprises a plurality of information vectors representing prior voxels and its neighborhood.

55. The reconstruction device according to claim 53, wherein the region growing circuit extracts a three-dimensional graph representation from the object image.

56. The reconstruction device according to claim 51, further comprising:
a display device that displays the object image or the graph representation as the cell structure image to be obtained.

57. The reconstruction device according to claim 51, which is included in an imaging device and further comprises:
a bright field microscope.

58. The reconstruction device according to claim 57, wherein the bright field microscope comprises a transmission bright field microscope.

59. The reconstruction device according to claim 57, wherein the bright field microscope comprises a mosaic imaging microscope.

60. A computer program residing on a computer-readable medium, with a program code that carries out the method according to claim 29.

61. Apparatus comprising a computer-readable storage medium containing program instructions, being arranged for carrying out the method according to claim 29.
